(19) United States
(12) Patent Application Publication
(10) Pub. No.: US 2024/0092147 A1
(43) Pub. Date: Mar. 21, 2024

(54) COOLING MEDIUM DISTRIBUTION APPARATUS FOR VEHICLE

(71) Applicant: Hyundai Wia Corporation, Changwon (KR)

(72) Inventors: Je Min Yeon, Incheon (KR); Sang Min Lee, Hwaseong (KR); Woo Yeon Cho, Sejong (KR)

(21) Appl. No.: 18/240,079

(22) Filed: Aug. 30, 2023

(30) Foreign Application Priority Data
Sep. 20, 2022 (KR) 10-2022-0118890

(51) Int. Cl. B60H 1/32; B60H 1/00

(52) U.S. Cl. CPC B60H 1/32; B60H 1/00278; B60H 1/00485; B60H 2001/3286

(57) ABSTRACT

A cooling medium distribution apparatus includes a valve housing having a valve body, a plurality of through-holes, and a plurality of distribution channels communicating with the respective through-holes, the plurality of distribution channels allowing a cooling medium to be distributed; a reservoir tank that communicates with the distribution channels, the reservoir tank storing or distributing the cooling medium; and a water pump that communicates with the through-holes and the distribution channels, the water pump distributing the cooling medium through the plurality of through-holes depending on a rotational position of the valve body. The cooling medium distribution apparatus may be installed in a vehicle to distribute the cooling medium to various cooling system parts.

### CROSS-REFERENCE TO RELATED APPLICATION

This application claims under 35 U.S.C. § 119(a) the benefit of Korean Patent Application No. 10-2022-0118890, filed on Sep. 20, 2022 with the Korean Intellectual Property Office, the entire contents of which are incorporated by reference herein.

### BACKGROUND

### 1. Technical Field

The present disclosure relates to a cooling medium distribution apparatus for a vehicle, more particularly, to the cooling medium distribution apparatus capable of distributing a coolant to various cooling system parts in the vehicle.

### 2. Description of the Related Art

Technology continues to evolve with respect to environmentally friendly vehicles, such as an electric vehicle or a fuel cell vehicle. Environmentally friendly vehicles typically are driven using electrical energy supplied from a battery, and therefore it is necessary to develop technology for improving electric efficiency.

In connection with electric efficiency, efficiency of a battery or a driving motor is important. In a vehicle having no engine, however, thermal management is performed using electrical energy since there is no heat source.

In the environmentally friendly vehicles, parts necessary to be thermally managed include a battery, electronic equipment, and an indoor air conditioner. It is necessary to manage the respective parts as an integrated system, rather than as independent systems, in order to positively utilize waste heat and to increase overall energy consumption efficiency of the vehicles.

When parts used to construct such an integrated thermal management system are adopted, it is possible to reduce space in a vehicle occupied by the integrated thermal management system and to reduce the weight of the integrated thermal management system, whereby it is possible to manufacture a more efficient vehicle.

The matters disclosed in this section are merely for enhancement of understanding of the general background of the disclosure and should not be taken as an acknowledgment or any form of suggestion that the matters form the related art already known to a person skilled in the art.

### SUMMARY

The present disclosure provides a cooling medium distribution apparatus capable of being installed in a vehicle, and which has a more compact structure, e.g., by omitting a plurality of peripheral pipes and distributing a coolant to various cooling system parts.

In one aspect, a cooling medium distribution apparatus is provided that comprises: 1) a valve housing comprising a valve body, a plurality of through-holes, and a plurality of distribution channels communicating with the respective through-holes, the plurality of distribution channels being configured to allow a cooling medium to be distributed therethrough; 2) a reservoir tank that communicates with the distribution channels, the reservoir tank being configured to store or distribute the cooling medium; and 3) a water pump that communicates with the through-holes and the distribution channels, the water pump being configured to distribute the cooling medium through the plurality of through-holes depending on a rotational position of the valve body. In certain embodiments, the reservoir tank and/or the water body are suitably mounted on the valve housing.

In accordance with a further aspect, a cooling medium distribution apparatus is provided that comprises a) a valve housing including a valve mounting portion, in which a valve body is provided, a plurality of through-holes formed along the circumference of the valve mounting portion, and a plurality of distribution channels communicating with the respective through-holes, the plurality of distribution channels being configured to allow a cooling medium to be distributed therethrough; b) a reservoir tank mounted to an upper side of the valve housing, the reservoir tank communicating with the distribution channels, the reservoir tank being configured to store or distribute the cooling medium; and c) a water pump mounted to the valve housing so as to be located lower than the reservoir tank, the water pump communicating with the through-holes and the distribution channels, the water pump being configured to distribute the cooling medium through the plurality of through-holes depending on the rotational position of the valve body.

The valve housing may include a valve mounting portion for receiving the valve body.

The valve housing suitably may be configured such that a mounting surface of the valve body and a mounting surface of the water pump are opposite each other.

The valve housing suitably may be formed such that the valve mounting portion is open to the front, whereby the valve body is inserted into the valve mounting portion from the front, and a valve actuator may be coupled to the front of the valve housing.

A sealing portion suitably may be provided between an outer circumferential surface of the valve body and an inner circumferential surface of the valve mounting portion, the sealing portion being configured to form a seal between the through-holes.

A flow hole suitably may be formed in the sealing portion at a position corresponding to each of the through-holes of the valve mounting portion.

The valve housing suitably may be provided with a port portion configured to allow the cooling medium to be introduced into or discharged from each of the plurality of distribution channels.

The valve housing suitably may be provided therein with a partition configured to branch the distribution channels for each port portion.

Un certain embodiments, each of the valve mounting portion and the valve body suitably may be divided into a plurality of layers.

The plurality of through-holes suitably may extend through the respective layers, and the plurality of through-holes suitably may be connected to the respective distribution channels.

The valve body suitably may be provided with a plurality of channel grooves formed for each of the layers, and the channel grooves formed at one layer may be separated from the channel grooves formed at another layer.

The channel grooves of the valve body for each layer suitably may be offset in a circumferential direction.

The cooling medium distribution apparatus suitably may further include a heat exchange module mounted to the valve housing, the heat exchange module being configured to exchange heat with the cooling medium.

In certain embodiments, the reservoir tank suitably may be partitioned into a first storage space and a second storage space, the heat exchange module may be partitioned into a first heat exchange portion and a second heat exchange portion, and the first storage space, the second storage space, the first heat exchange portion, and the second heat exchange portion may be communicatively connected to each of the distribution channels of the valve housing.

In certain embodiments, the valve mounting portion suitably may be disposed in the center of the valve housing, a first distribution region and a second distribution region may be partitioned from the center to one side and another side, and the plurality of through-holes and the plurality of distribution channels may be formed in each of the first distribution region and the second distribution region.

The water pump suitably may be constituted by a first water pump and a second water pump, and the first water pump may be mounted in the first distribution region while the second water pump may be mounted in the second distribution region.

A distribution channel communicating with the first water pump suitably may be provided in the center of the first distribution region, and distribution channels communicating with the first storage space and the first heat exchange portion may be formed respectively at an upper side and a lower side of the first distribution channel.

A distribution channel communicating with the second water pump suitably may be provided in the center of the second distribution region, and distribution channels communicating with the second storage space and the second heat exchange portion suitably may be formed respectively at an upper side and a lower side of the second distribution channel.

According to the present disclosure, a vehicle may include the cooling medium distribution apparatus.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a cooling medium distribution apparatus according to an embodiment of the present disclosure;

FIG. 2 is an assembled view of the cooling medium distribution apparatus shown in FIG. 1;

FIG. 3 is a view showing a valve housing and a valve body of the cooling medium distribution apparatus shown in FIG. 1;

FIG. 4 is a sectional view of the valve housing of the cooling medium distribution apparatus shown in FIG. 1;

FIG. 5 is a view showing layers of the cooling medium distribution apparatus shown in FIG. 1;

FIG. 6 is a cooling circuit diagram to which the cooling medium distribution apparatus according to the present disclosure is applied;

FIG. 7 is a view showing an embodiment of cooling circulation in the cooling circuit diagram according to the present disclosure;

FIG. 8 is a view showing layers of a valve housing in the cooling circuit diagram according to the embodiment shown in FIG. 7;

FIG. 9 is a view showing another embodiment of cooling circulation in the cooling circuit diagram according to the present disclosure;

FIG. 10 is a view showing layers of a valve housing in the cooling circuit diagram according to the embodiment shown in FIG. 9;

FIG. 11 is a view showing another embodiment of cooling circulation in the cooling circuit diagram according to the present disclosure;

FIG. 12 is a view showing layers of a valve housing in the cooling circuit diagram according to the embodiment shown in FIG. 11;

FIG. 13 is a view showing a further embodiment of cooling circulation in the cooling circuit diagram according to the present disclosure; and

FIG. 14 is a view showing layers of a valve housing in the cooling circuit diagram according to the further embodiment shown in FIG. 13.

### DETAILED DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Description will now be given in detail according to embodiments disclosed herein with reference to the accompanying drawings. For the sake of brief description with reference to the drawings, the same or equivalent elements may be provided with the same reference numbers, and description thereof will not be repeated.

In describing embodiments disclosed herein, a detailed description of known functions and configurations incorporated herein will be omitted when it may make the subject matter of the present disclosure rather unclear. In addition, the accompanying drawings are used to aid in ease of understanding various technical features and it should be understood that embodiments disclosed herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that, when an element is referred to as being “connected to” or “coupled to” another element, it may be directly connected to or coupled to the other element, or intervening elements may be present. In contrast, when an element is referred to as being “directly connected to” or “directly coupled to” another element, there are no intervening elements present.

A singular representation may include a plural representation unless it represents a definitely different meaning from the context.

In addition, “unit” or “control unit” included in names, such as a motor control unit (MCU) and a hybrid control unit (HCU), is a term that is widely used to name a controller that controls a specific function of a vehicle, but does not mean a generic functional unit.

Each control unit may include a communication device that communicates with another control unit or a sensor in order to control an assigned function, a memory that stores an operating system, logic commands, and input and output information, and at least one processor that performs determination, calculation, and decision necessary to control the assigned function.

Hereinafter, exemplary embodiments of a cooling medium distribution apparatus according to the present disclosure will be described with reference to the accompanying drawings.

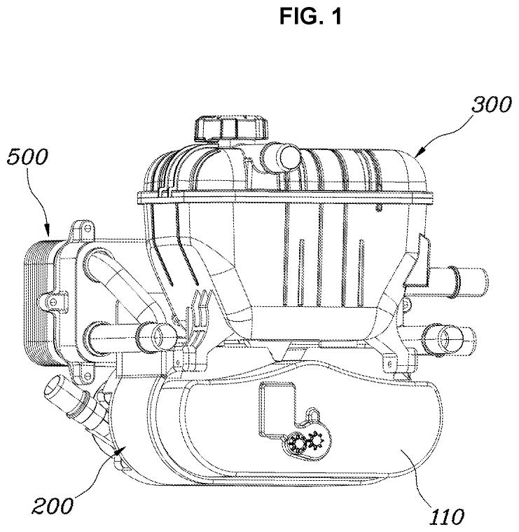

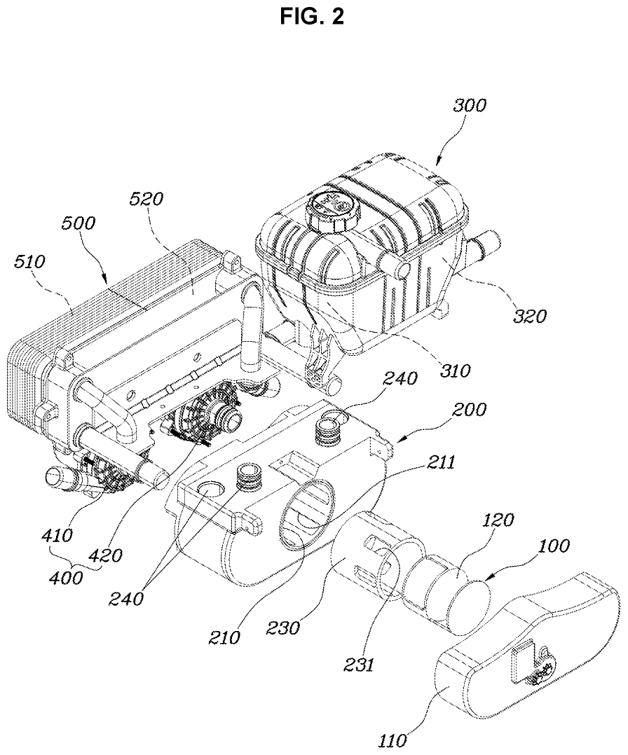

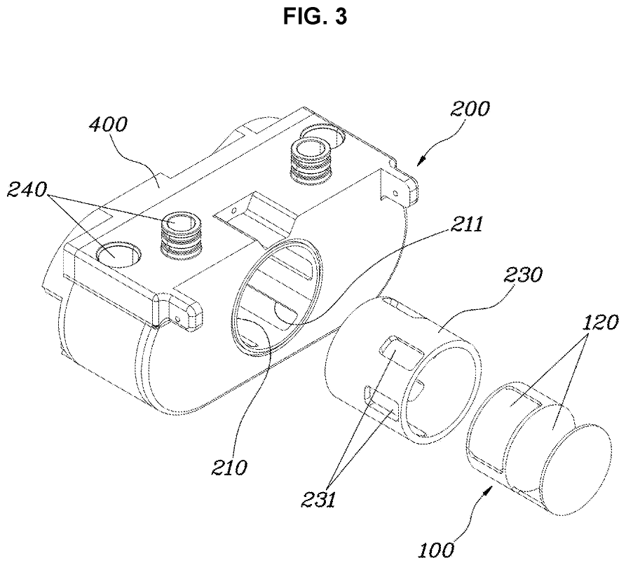

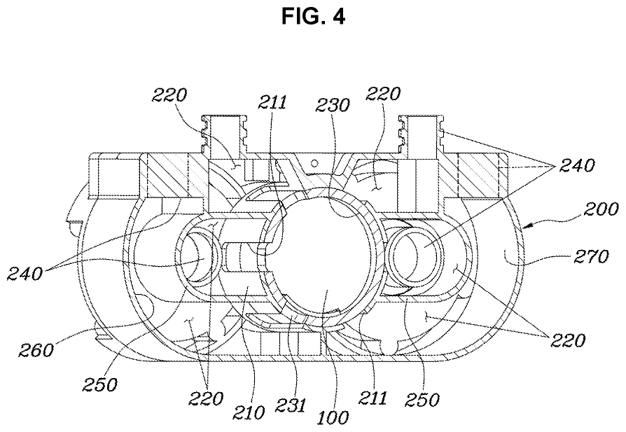

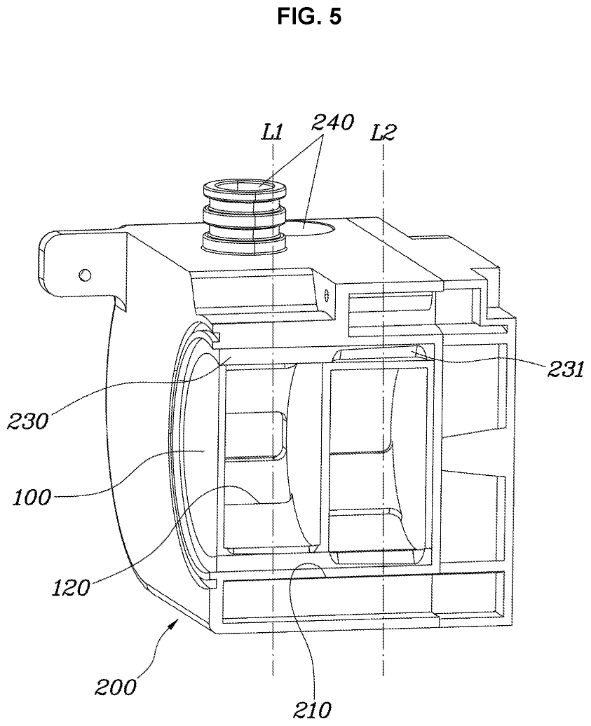

FIG. 1 is a view showing a cooling medium distribution apparatus according to an embodiment of the present disclosure, FIG. 2 is an assembled view of the cooling medium distribution apparatus shown in FIG. 1, FIG. 3 is a view showing a valve housing and a valve body of the cooling medium distribution apparatus shown in FIG. 1, FIG. 4 is a sectional view of the valve housing of the cooling medium distribution apparatus shown in FIG. 1, and FIG. 5 is a view showing layers of the cooling medium distribution apparatus shown in FIG. 1.

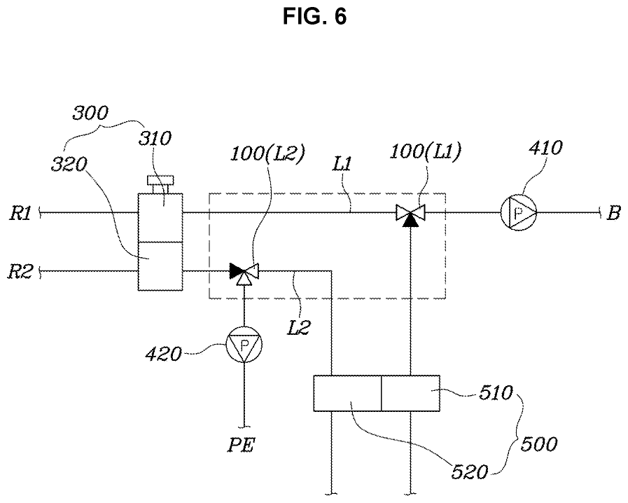

FIG. 6 is a cooling circuit diagram to which the cooling medium distribution apparatus according to the present disclosure is applied.

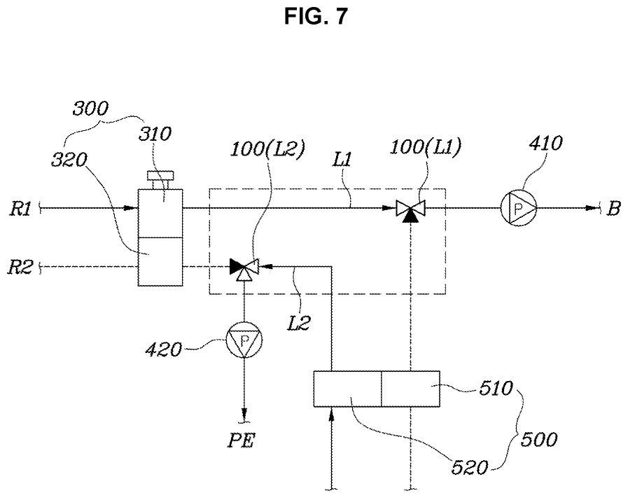

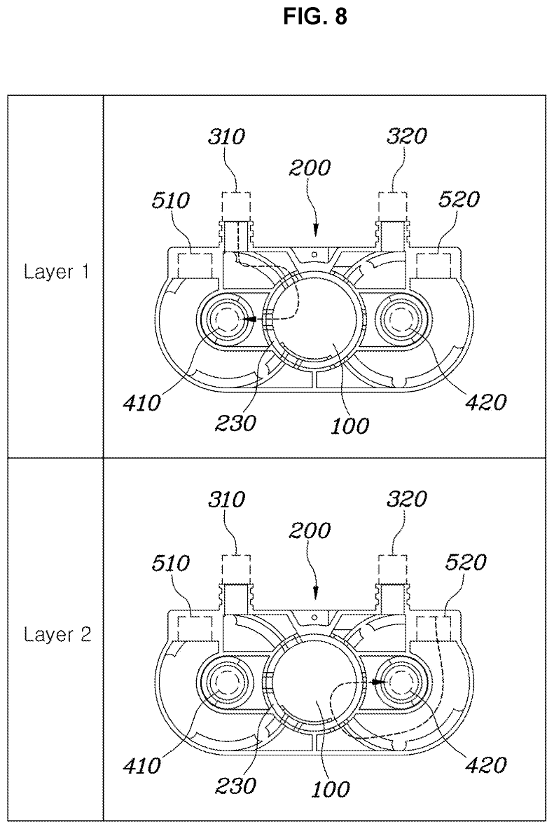

FIG. 7 is a view showing an embodiment of cooling circulation in the cooling circuit diagram according to the present disclosure, and FIG. 8 is a view showing layers of a valve housing in the cooling circuit diagram according to the embodiment shown in FIG. 7.

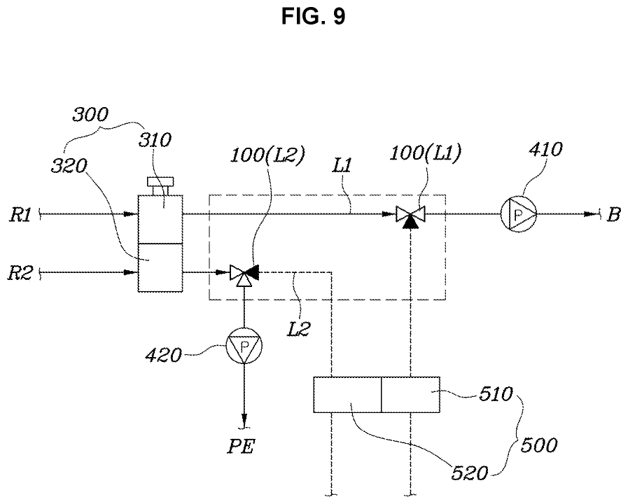

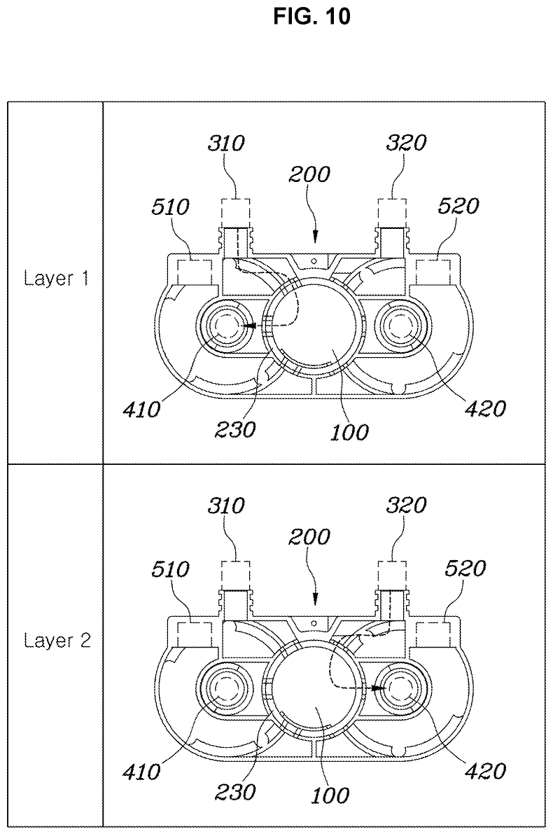

FIG. 9 is a view showing another embodiment of cooling circulation in the cooling circuit diagram according to the present disclosure, and FIG. 10 is a view showing layers of a valve housing in the cooling circuit diagram according to other embodiment shown in FIG. 9.

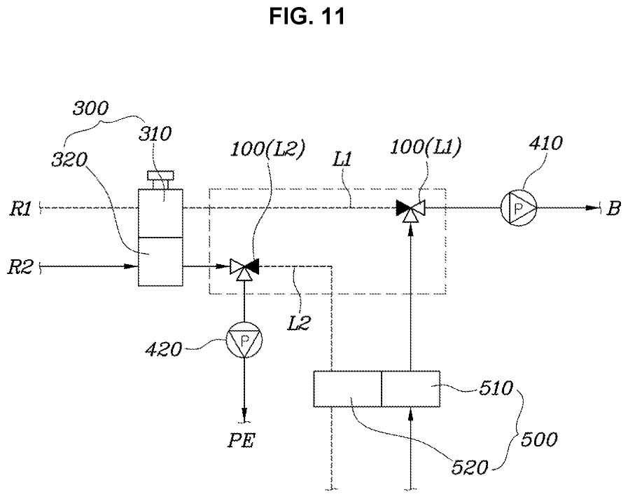

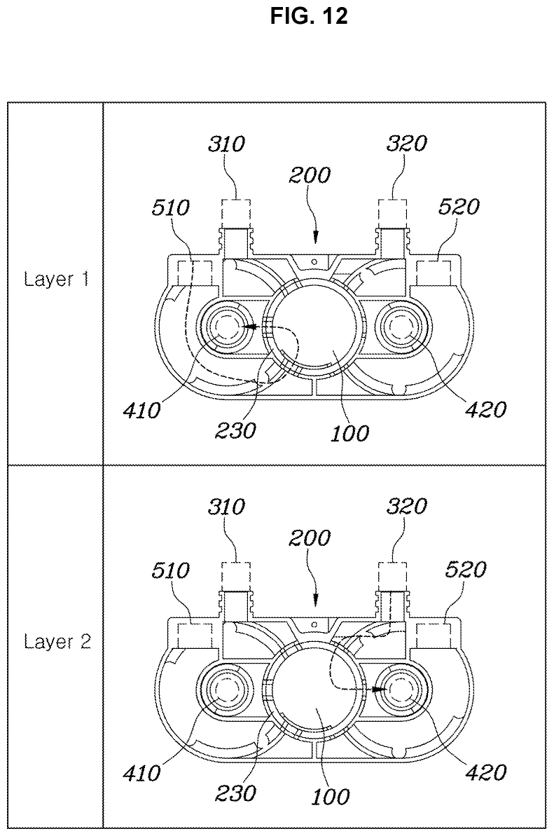

FIG. 11 is a view showing another embodiment of cooling circulation in the cooling circuit diagram according to the present disclosure, and FIG. 12 is a view showing layers of a valve housing in the cooling circuit diagram according to other embodiment shown in FIG. 11.

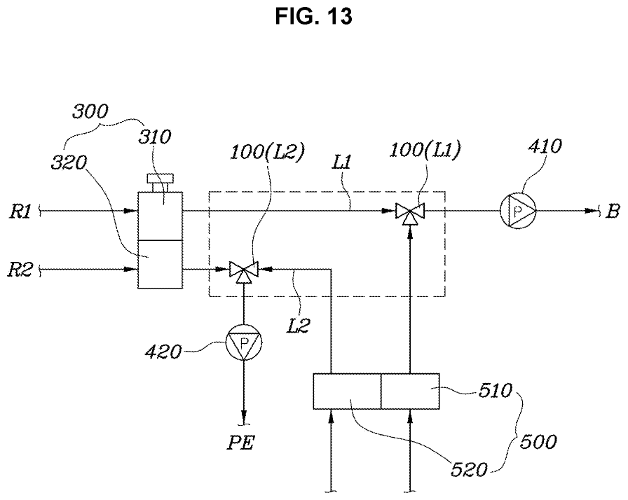

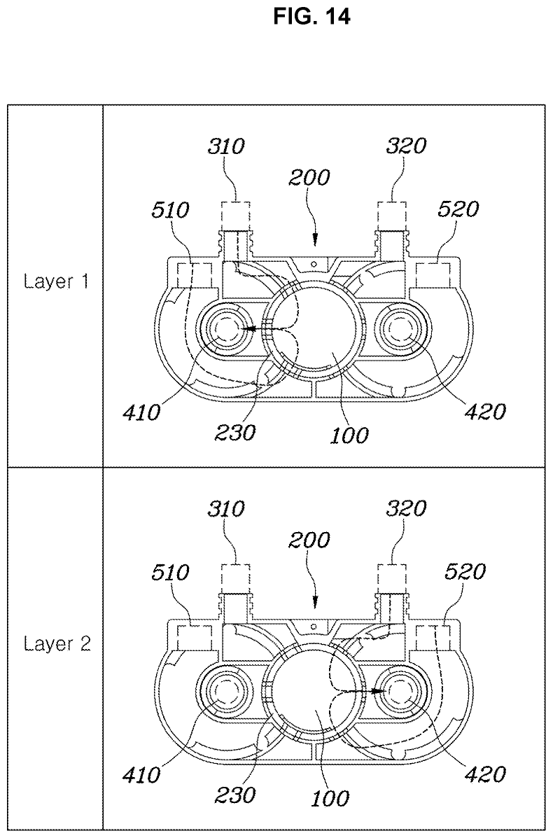

FIG. 13 is a view showing a further embodiment of cooling circulation in the cooling circuit diagram according to the present disclosure, and FIG. 14 is a view showing layers of a valve housing in the cooling circuit diagram according to the further embodiment shown in FIG. 13.

As shown in FIGS. 1 to 5, a cooling medium distribution apparatus according to an embodiment of the present disclosure includes a valve housing 200 including a valve mounting portion 210, in which a valve body 100 is provided, a plurality of through-holes 211 formed along the circumference of the valve mounting portion 210, and a plurality of distribution channels 220 communicating with the respective through-holes 211, the plurality of distribution channels being configured to allow a cooling medium to be distributed therethrough, a reservoir tank 300 mounted to an upper side of the valve housing 200, the reservoir tank communicating with the distribution channels 220, the reservoir tank being configured to store or distribute the cooling medium, and a water pump 400 mounted to the valve housing 200 so as to be located lower than the reservoir tank 300, the water pump communicating with the through-holes 211 and the distribution channels 220, the water pump being configured to distribute the cooling medium through the plurality of through-holes 211 depending on the rotational position of the valve body 100.

The valve housing 200 of the present disclosure has the valve mounting portion 210, in which the valve body 100 is provided, and the valve body 100 is rotatably provided in the valve mounting portion 210. In addition, the valve mounting portion 210 is provided in the valve housing 200, whereby the valve body 100 is located in the valve housing 200, and therefore it is possible to provide a compact structure even though the valve body 100 is provided.

The valve housing 200 may be provided with a valve actuator 110 configured to control the rotational position of the valve body 100. The valve mounting portion 210 may be configured to be closed when the valve actuator 110 is mounted to the valve housing 200. The valve actuator 110 may be controlled by a control unit.

The plurality of through-holes 211 is formed along the circumference of the valve mounting portion 210, and the through-holes 211 are connected to the distribution channels 220 formed at the valve housing 200, whereby the cooling medium may be distributed through a specific through-hole 211 and a specific distribution channel 220 depending on the rotational position of the valve body 100.

The valve mounting portion 210 may be formed in a cylindrical shape. Since the valve mounting portion 210 is provided in the valve housing 200, the valve mounting portion 210 may be formed in a shape depressed inwardly of the valve housing 200.

In addition, the plurality of distribution channels 220 is formed around the valve mounting portion 210 of the valve housing 200. The distribution channels 220 are formed so as to communicate respectively with the through-holes 211 of the valve mounting portion 210. When the cooling medium is distributed through each through-hole 211 depending on the rotational position of the valve body 100, therefore, the cooling medium may pass through the distribution channels 220 so as to flow to other cooling system parts. Since the valve body 100 is provided in the valve mounting portion 210 and the cooling medium is distributed through a corresponding one of the through-holes 211 and a corresponding one of the distribution channels 220 depending on the rotational position of the valve body 100, as described above, various thermal management modes may be performed through selective distribution of the cooling medium to a plurality of cooling system parts.

Meanwhile, the valve housing 200 is configured such that a mounting surface of the valve body 100 via the valve mounting portion 210 and a mounting surface of the water pump 400 are opposite each other.

In addition, the valve body 100 and the water pump 400 may be mounted to the valve housing 200 in a horizontal direction. That is, the valve body 100 and the water pump 400 are mounted around the valve housing 200 in the horizontal direction, whereby mounting and management of the valve body 100 and the water pump 400 are simplified.

That is, the valve housing 200 is formed such that the valve mounting portion 210 is open to the front, whereby the valve body 100 is inserted into the valve mounting portion 210 from the front, and the valve actuator 110 is coupled to the front of the valve housing 200. In addition, the water pump 400 is mounted to the rear of the valve housing 200. As a result, the valve body 100, the valve actuator 110, and the water pump 400 may be mounted to the valve housing 200 without interference therebetween, the package is reduced, and switching between cooling medium distribution paths depending on the rotational position of the valve body 100 in the valve housing 200 and distribution of the cooling medium by the water pump 400 may be smoothly performed.

Meanwhile, since the reservoir tank 300 is mounted to the valve housing 200 so as to be located above the water pump 400, efficiency in removal of air through the reservoir tank 300 is improved. The reservoir tank 300 may be partitioned so as to correspond to parts necessary to be cooled (e.g., a battery or an electrical part), and may have a water level sensor mounted therein in order to check the capacity of the cooling medium. In particular, since the reservoir tank 300 is disposed at an upper side of the valve housing 200, efficiency in removal of air from the cooling medium is maximized, whereby damage to the parts due to air included in the cooling medium is prevented.

Meanwhile, a sealing portion 230 is provided between an outer circumferential surface of the valve body 100 and an inner circumferential surface of the valve mounting portion 210 in order to form a seal between the through-holes 211. The position of the sealing portion 230 is fixed in the state in which the sealing portion is located between the valve body 100 and the valve mounting portion 210, and the valve body 100 is rotated relative to the sealing portion 230.

As described above, the sealing portion 230 is provided between the outer circumferential surface of the valve body 100 and the inner circumferential surface of the valve mounting portion 210 to form a seal between the through-holes 211. The sealing portion 230 may be formed in a cylindrical shape, and is configured such that the valve body 100 is rotated relative to the sealing portion 230. Flow holes 231, through which the cooling medium is distributed between the valve body 100 and the through-holes 211, are formed in the sealing portion 230, whereby the flow of the cooling medium is not impeded when the sealing portion 160 forms a seal between the valve body 100 and the through-holes 211.

Meanwhile, the valve housing 200 may be provided with port portions 240 configured to allow the cooling medium to be introduced into or discharged from the plurality of distribution channels 220. The port portions 240, which are parts at which the reservoir tank 300 and the water pump 400 are connected to the valve housing 200 such that the cooling medium is distributed, may be formed so as to extend from the valve housing 200 or to be depressed from the valve housing 200. As an example, among the port portions 240 of the valve housing 200, the port portion 240 to which the reservoir tank 300 is mounted may be formed so as to extend upwards, and the port portion 240 to which the water pump 400 is mounted may be formed in the shape of a hole such that the water pump 400 is inserted thereinto.

In addition, the valve housing may be provided therein with a partition 250 configured to branch the distribution channels 220 for each port portion 240.

The plurality of distribution channels 220 may be branched for each port portion 240 communicating with a corresponding one of the through-holes 211 of the valve mounting portion 210 by the partition 250 formed in the valve housing 200. As shown in FIG. 4, the partition 250, which defines the distribution channels 220, extends in the valve housing 200, and the partition 250 defines a distribution channel 220 communicating with a specific through-hole 211 of the valve mounting portion 210 and a specific port portion 240, whereby the cooling medium may be distributed separately through the respective distribution channels 220.

Meanwhile, each of the valve mounting portion 210 and the valve body 100 may be divided into a plurality of layers L1 and L2. In addition, the sealing portion 230 is also constituted by a plurality of layers.

Since each of the valve mounting portion 210, the valve body 100, and the sealing portion 230 is constituted by the plurality of layers L1 and L2, as described above, the distribution direction of the cooling medium may be diversified. In addition, a plurality of cooling medium distribution paths is formed at the plurality of layers L1 and L2, and some of the cooling medium distribution paths are shared, whereby a larger number of flows of the cooling medium than the number of port portions 240 may be formed. In the embodiment of the present disclosure, six port portions 240 may be provided, and six or more flows of the cooling medium may be formed. In the following embodiment, the construction in which the layers L1 and L2 are constituted by a first layer L1 and a second layer L2 will be described by way of example.

Specifically, the plurality of through-holes 211 may extend through the respective layers L1 and L2, and the plurality of through-holes 211 may be connected to the respective distribution channels 220.

Here, the valve body 100 may be provided with a plurality of channel grooves 120 formed for each of the layers L1 and L2, and the channel grooves 120 formed at one layer may be separated from the channel grooves 120 formed at the another layer.

In addition, the channel grooves 120 of the valve body 100 for each of the layers L1 and L2 may be offset in a circumferential direction.

That is, the through-holes 211 of the valve mounting portion 210 extend so as to include both the first layer L1 and the second layer L2, and the channel grooves 120 are formed at the valve body 100 for each of the layers L1 and L2. The channel grooves 120 may be offset at each of the layers L1 and L2 of the valve body 100, and may be formed so as to be depressed in a fan shape. This is based on one embodiment of the present disclosure, and the shape and number of the channel grooves 120 may be variously changed. As a result, when a specific channel groove matches a corresponding one of the through-holes 211 depending on the rotational position of the valve body 100, the cooling medium may be distributed through the through-hole 211 connected to the specific channel groove 120.

As described above, the flow of the cooling medium may be diversified depending on the rotational position of the valve body 100, and a cooling function may be diversified according to the flow direction of the cooling medium.

Meanwhile, a heat exchange module 500 mounted to the valve housing 200 and configured to exchange heat with the cooling medium may be further included.

The heat exchange module 500 may be constituted by a chiller or a radiator, and may be configured to perform heat exchange between the cooling medium and another cooling medium, such as a refrigerant or a coolant, in order to manage the temperature of the cooling medium.

The heat exchange module 500 may be mounted to the valve housing 200 so as to be located above the water pump 400, and may be provided so as not to interfere with other parts.

Meanwhile, in an embodiment of the present disclosure, the reservoir tank 300 may be partitioned into a first storage space 310 and a second storage space 320, the heat exchange module 500 may be partitioned into a first heat exchange portion 510 and a second heat exchange portion 520, and the first storage space 310, the second storage space 320, the first heat exchange portion 510, and the second heat exchange portion 520 may be communicatively connected to each of the distribution channels 220 of the valve housing 200.

Since the interior of the reservoir tank 300 is partitioned into a plurality of storage spaces, the cooling medium may be separately managed for each of a plurality of parts necessary to be cooled.

In addition, since the heat exchange module 500 is partitioned into the first heat exchange portion 510 and the second heat exchange portion 520, the temperature of the cooling medium may be separately managed for each of a plurality of parts necessary to be cooled.

Here, the cooling medium distributed to the first storage space 310 and the first heat exchange portion 510 may flow to a battery B, and the cooling medium distributed to the second storage space 320 and the second heat exchange portion 520 may flow to an electric part PE.

In the present disclosure, therefore, a heat pump may be implemented by managing the cooling medium flowing to the battery B and the temperature of the cooling medium flowing to the electric part PE.

Specifically, the valve mounting portion 210 may be disposed in the center of the valve housing 200, a first distribution region 260 and a second distribution region 270 are partitioned from the center to one side and another side, and the plurality of through-holes 211 and the plurality of distribution channels 220 may be formed in each of the first distribution region 260 and the second distribution region 270.

The water pump 400 is constituted by a first water pump 410 and a second water pump 420. The first water pump 410 is mounted in the first distribution region 260, and the second water pump 420 is mounted in the second distribution region 270.

Since the valve mounting portion 210 is disposed in the center of the valve housing 200, it is easy to radially form the plurality of distribution channels 220 from the valve mounting portion 210. In addition, the rotational range of the valve body 100 provided in the valve mounting portion 210 is secured, whereby it is possible to secure the cooling medium distribution path depending on the rotational position of the valve body 100.

That is, the valve mounting portion 210 is disposed in the center of the valve housing 200, the first storage space 310 of the reservoir tank 300, the first heat exchange portion 510, and the first water pump 410 are connected to one side of the valve mounting portion 210 in the first distribution region 260, and the second storage space 320 of the reservoir tank 300, the second heat exchange portion 520, and the second water pump 420 are connected to another side of the valve mounting portion 210 in the second distribution region 270, whereby the distribution direction of the cooling medium may be changed for each of the layers L1 and L2 depending on the rotational position of the valve body 100.

Specifically, a distribution channel 220 communicating with the first water pump 410 is provided in the center of the first distribution region 260, and distribution channels 220 communicating with the first storage space 310 and the first heat exchange portion 510 are formed respectively at an upper side and a lower side of the first distribution channel 220.

Since the distribution channel 220 communicating with the first water pump 410 is provided in the center of the first distribution region 260, as described above, the flow of the cooling medium distributed to the distribution channel 220 communicating with the first water pump 410 from another distribution channel 220 via the valve body 100 may be smoothly formed during operation of the first water pump 410. Also, it is preferable for the cooling medium to be distributed in the center of the first distribution region 260 due to structural characteristics of the first water pump 410.

In an embodiment of the present disclosure, therefore, the distribution channel 220 communicating with the first water pump 410 is disposed in the center of the first distribution region 260, the distribution channel 220 connected to the first storage space 310 of the reservoir tank 300 is disposed at the upper side thereof, and the distribution channel 220 connected to the first heat exchange portion 510 is disposed at the lower side thereof, whereby the plurality of distribution channels 220 is partitioned in the first distribution region 260, and therefore different cooling medium distribution paths may be formed. Consequently, a through-hole 211 corresponding to each distribution channel 220 may be formed in the valve mounting portion 211, and the cooling medium that flows to the battery B may be distributed through the first storage space 310 and the first heat exchange portion 510.

Meanwhile, a distribution channel 220 communicating with the second water pump 420 may be provided in the center of the second distribution region 270, and distribution channels 220 communicating with the second storage space 320 and the second heat exchange portion 520 may be formed respectively at an upper side and a lower side of the second distribution channel 220.

Since the distribution channel 220 communicating with the second water pump 420 is provided in the center of the second distribution region 270, as described above, the flow of the cooling medium distributed to the distribution channel 220 communicating with the second water pump 420 from another distribution channel 220 via the valve body 100 may be smoothly formed during operation of the second water pump 420. Also, it is preferable for the cooling medium to be distributed in the center of the second distribution region 270 due to structural characteristics of the second water pump 420.

In an embodiment of the present disclosure, therefore, the distribution channel 220 communicating with the second water pump 420 is disposed in the center of the second distribution region 270, the distribution channel 220 connected to the second storage space 320 of the reservoir tank 300 is disposed at the upper side thereof, and the distribution channel 220 connected to the second heat exchange portion 520 is disposed at the lower side thereof, whereby the plurality of distribution channels 220 is partitioned in the second distribution region 270, and therefore different cooling medium distribution paths may be formed. Consequently, a through-hole 211 corresponding to each distribution channel 220 may be formed in the valve mounting portion 211, and the cooling medium that flows to the electric part PE may be distributed through the second storage space 320 and the second heat exchange portion 520.

The cooling medium distribution apparatus according to the present disclosure may be applied to a cooling circuit shown in FIG. 6.

That is, the first cooling medium line L1 may include the first water pump 410, the battery B, a first radiator R1, the first storage space 310 of the reservoir tank 300, and the first heat exchange portion 510 of the heat exchange module 500 such that the cooling medium is circulated. Here, the first cooling medium line L1 may further include a water heater. The second cooling medium line L2 may include the second water pump 420, the electric part PE, a second radiator R2, the second storage space 320 of the reservoir tank 300, and the second heat exchange portion 520 of the heat exchange module 500 such that the cooling medium is circulated.

In the present disclosure, the distribution direction of the cooling medium is changed by one valve body 100 for each of the layers L1 and L2, although a plurality of valves is shown as being provided in FIG. 6.

In the present disclosure, therefore, the flow of the cooling medium may be diversified, and a cooling function may be diversified according to the flow direction of the cooling medium.

As shown in FIG. 7, the battery B may be cooled by the cooling medium that has exchanged heat with the first heat exchange portion 510 of the heat exchange module 500 and the first radiator R1 in the first cooling medium line L1, and the electric part PE may be cooled by the cooling medium that has exchanged heat with the heat exchange module 500 in the second cooling medium line L2.

As shown in FIG. 8, therefore, the flow of the cooling medium distributed to the first storage space 310 of the reservoir tank 300, the valve body 100, and the first water pump 410 may be formed in the first distribution region 260 of the first layer L1, and the flow of the cooling medium distributed to the second heat exchange portion 520 of the heat exchange module 500, the valve body 100, and the second water pump 420 may be formed in the second distribution region 270 of the second layer L2.

Meanwhile, as shown in FIG. 9, the battery B may be cooled by the cooling medium that has exchanged heat with the first heat exchange portion 510 of the heat exchange module 500 and the first radiator R1 in the first cooling medium line L1, and the electric part PE may be cooled by the cooling medium that has exchanged heat with the second radiator R2 in the second cooling medium line L2.

As shown in FIG. 10, therefore, the flow of the cooling medium distributed to the first storage space 310 of the reservoir tank 300, the valve body 100, and the first water pump 410 may be formed in the first distribution region 260 of the first layer L1, and the flow of the cooling medium distributed to the second storage space 320 of the reservoir tank 300, the valve body 100, and the second water pump 420 may be formed in the second layer L2.

In addition, as shown in FIG. 11, the temperature of the battery B may be increased as the result of the cooling medium being circulated without heat exchange in the first cooling medium line L1, and the electric part PE may be cooled by the cooling medium that has exchanged heat with the second radiator R2 in the second cooling medium line L2.

As shown in FIG. 12, therefore, the flow of the cooling medium distributed to the first heat exchange portion 510 of the heat exchange module 500, the valve body 100, and the first water pump 410 may be formed in the first layer L1, and the flow of the cooling medium distributed to the second storage space 320 of the reservoir tank 300, the valve body 100, and the second water pump 420 may be formed in the second layer L2.

Meanwhile, as shown in FIG. 13, the valve body 100 may match all of the through-holes 211 such that the cooling medium is distributed through all paths. As a result, the cooling medium may pass through the heat exchange module 500 and the first radiator R1 and may cool the battery B in the first cooling medium line L1, and the cooling medium may pass through the heat exchange module 500 and the second radiator R2 and may cool the electric part PE in the second cooling medium line L2. In the heat exchange module 500, the cooling medium exchanges heat with the first heat exchange portion 510 and the second heat exchange portion 520, whereby the temperature of the cooling medium may be adjusted.

As shown in FIG. 14, therefore, the flow of the cooling medium distributed from the first storage space 310 and the first heat exchange portion 510 to the first water pump 410 via the valve body 100 may be formed in the first layer L1, and the flow of the cooling medium distributed from the second storage space 320 and the second heat exchange portion 520 to the second water pump 420 via the valve body 100 may be formed in the second layer L2.

In the present disclosure, as described above, the cooling medium is selectively distributed to each of the through-holes 211 and each of the distribution channels depending on the shape of the valve body 100, and the rotation position of the valve body 100 is adjusted to form various flows of the cooling medium. Consequently, various thermal management modes may be implemented based on the flow of the cooling medium.

The cooling medium distribution apparatus configured to have the above structure may be installed in a vehicle as a compact structure with omission of a plurality of peripheral pipes, and may distribute a coolant to various cooling system parts.

In particular, the reservoir tank 300, the water pump 400, and the heat exchange module 500 are disposed around the valve housing 200, whereby manufacture and management thereof are simplified through optimum disposition of the respective parts at the valve housing 200. In addition, connection through the respective ports is possible without branch pipes, which is very advantageous to modularization of the cooling system parts.

As is apparent from the above description, the present disclosure has an effect in that the cooling medium distribution apparatus configured to have the above structure is capable of being installed in a vehicle as a compact structure with omission of a plurality of peripheral pipes and distributing a coolant to various cooling system parts.

In particular, the reservoir tank, the water pump, and the heat exchange module may be disposed around the valve housing, whereby manufacture and management thereof may be simplified through optimum disposition of the respective parts at the valve housing. In addition, connection through the respective ports is possible without branch pipes, which is very advantageous to modularization of the cooling system parts.

Although the present disclosure has been described with reference to the accompanying drawings and the above preferred embodiment, the present disclosure is not defined thereby but by the appended claims. Accordingly, it will be apparent to those skilled in the art that various modifications and variations can be made in the present disclosure without departing from the technical idea of the appended claims.

What is claimed is:

1. A cooling medium distribution apparatus comprising:
a valve housing comprising a valve body, a plurality of through-holes, and a plurality of distribution channels communicating with the respective through-holes, the plurality of distribution channels being configured to allow a cooling medium to be distributed therethrough;
a reservoir tank that communicates with the distribution channels, the reservoir tank being configured to store or distribute the cooling medium; and
a water pump that communicates with the through-holes and the distribution channels, the water pump being configured to distribute the cooling medium through the plurality of through-holes depending on a rotational position of the valve body.

2. The cooling medium distribution apparatus according to claim 1, wherein the valve housing is configured such that a mounting surface of the valve body and a mounting surface of the water pump are opposite each other.

3. The cooling medium distribution apparatus according to claim 1, wherein the valve housing comprises a valve mounting portion for receiving the valve body.

4. The cooling medium distribution apparatus according to claim 3, wherein:
the valve housing is formed such that the valve mounting portion is open to a front, whereby the valve body is inserted into the valve mounting portion from the front, and
a valve actuator is coupled to the front of the valve housing.

5. The cooling medium distribution apparatus according to claim 3, wherein a sealing portion is provided between an outer circumferential surface of the valve body and an inner circumferential surface of the valve mounting portion, the sealing portion being configured to form a seal between the through-holes.

6. The cooling medium distribution apparatus according to claim 5, wherein a flow hole is formed in the sealing portion at a position corresponding to each of the through-holes.

7. The cooling medium distribution apparatus according to claim 1, wherein the valve housing is provided with a port portion configured to allow the cooling medium to be introduced into or discharged from each of the plurality of distribution channels.

8. The cooling medium distribution apparatus according to claim 7, wherein the valve housing is provided therein with a partition configured to branch the distribution channels for each port portion.

9. The cooling medium distribution apparatus according to claim 1, wherein:
the valve housing comprises a valve mounting portion for receiving the valve body,
the plurality of through-holes are formed along a circumference of the valve mounting portion and
each of the valve mounting portion and the valve body is divided into a plurality of layers.

10. The cooling medium distribution apparatus according to claim 9, wherein
the plurality of through-holes extend through the respective layers, and
the plurality of through-holes is connected to the respective distribution channels.

11. The cooling medium distribution apparatus according to claim 9, wherein:
the valve body is provided with a plurality of channel grooves formed for each of the layers, and
the channel grooves formed at one layer are separated from the channel grooves formed at another layer.

12. The cooling medium distribution apparatus according to claim 11, wherein the channel grooves of the valve body for each layer are offset in a circumferential direction.

13. The cooling medium distribution apparatus according to claim 1, further comprising a heat exchange module mounted to the valve housing, the heat exchange module being configured to exchange heat with the cooling medium.

14. The cooling medium distribution apparatus according to claim 13, wherein:
the reservoir tank is partitioned into a first storage space and a second storage space,
the heat exchange module is partitioned into a first heat exchange portion and a second heat exchange portion, and
the first storage space, the second storage space, the first heat exchange portion, and the second heat exchange portion are communicatively connected to each of the distribution channels of the valve housing.

15. The cooling medium distribution apparatus according to claim 14, wherein:
a valve mounting portion is disposed in a center of the valve housing,
a first distribution region and a second distribution region are partitioned from the center to one side and another side, and
the plurality of through-holes and the plurality of distribution channels are formed in each of the first distribution region and the second distribution region.

16. The cooling medium distribution apparatus according to claim 15, wherein:
the water pump is constituted by a first water pump and a second water pump, and
the first water pump is mounted in the first distribution region while the second water pump is mounted in the second distribution region.

17. The cooling medium distribution apparatus according to claim 15, wherein:
a distribution channel communicating with the first water pump is provided in a center of the first distribution region, and
distribution channels communicating with the first storage space and the first heat exchange portion are formed respectively at an upper side and a lower side of the first distribution channel.

18. The cooling medium distribution apparatus according to claim 15, wherein:
a distribution channel communicating with the second water pump is provided in a center of the second distribution region, and
distribution channels communicating with the second storage space and the second heat exchange portion are formed respectively at an upper side and a lower side of the second distribution channel.

19. A vehicle comprising the cooling medium distribution apparatus of claim 1.
